(19) United States
(12) Patent Application Publication
(10) Pub. No.: US 2021/0153531 A1
(43) Pub. Date: May 27, 2021

(54) DRIED POWDER OF EDIBLE PLANT, FOOD AND BEVERAGE, AND PRODUCTION METHOD THEREFOR

(71) Applicant: MIZKAN HOLDINGS CO., LTD., Aichi (JP)

(72) Inventors: Tatsuya Higuchi, Aichi (JP); Junichiro Ihara, Aichi (JP)

(73) Assignee: MIZKAN HOLDINGS CO., LTD., Aichi (JP)

(21) Appl. No.: 17/165,113

(22) Filed: Feb. 2, 2021

Related U.S. Application Data
(63) Continuation of application No. PCT/JP2019/031589, filed on Aug. 9, 2019.

(30) Foreign Application Priority Data
Jan. 23, 2019 (JP) 2019-009766

(51) Int. Cl. A23L 19/00; A23L 19/10; A23L 11/00; A23L 2/52; A23L 33/105

(52) U.S. Cl. CPC A23L 19/01; A23L 19/105; A23V 2002/00; A23L 2/52; A23L 33/105; A23L 11/07

(57) ABSTRACT

A dried powder of an edible plant which hardly gets damped, without relying on a substance other than a dried edible plant serving as a main food material for imparting features to a flavor and a color tone of a dried powder, and a method for producing the same is provided. The dried powder contains an edible part and a non-edible part of a dried edible plant which a proportion of the non-edible part to the edible part of the dried edible plant is 1% by mass or more and 200% by mass or less, a repose angle is 0.7 rad or more, loose bulk density/tight bulk density is 0.88 or less and a moisture content is 20% by mass or less.

### TECHNICAL FIELD

One or more embodiments of the present invention relate to a dried powder of an edible plant, a food and beverage and a method for producing the same.

### BACKGROUND

Since a dried powder of a food contains a small amount of moisture and has a large surface area, it can absorb moisture in an atmosphere and get damped easily. When the dried powder gets damped, it the usability becomes poor due to generation of lump up, or that the microorganisms propagate and the flavor and color tone deteriorate.

As a technique relating to prevention of damping of dried powder, Patent Literature 1 discloses a technique relating to a film for packaging a powdered food which has a sufficient barrier property when it is made into a bag, and which protects the powdered food from moisture and air (oxygen) to prevent deterioration of the quality of the powdered food.

However, a special packaging bag needed to be used. In addition, a method of enclosing a desiccant containing a moisture absorbent such as silica gel, but there is still a possibility of contamination.

Therefore, there has been a need for a technique to prevent from quality deterioration caused by damping, by using a dietary material only. For example, Patent Literature 2 discloses a technique relating to a baked food which is baked by covering at least an outer surface with an edible film material. Patent Literature 3 discloses a technique relating to a moisture absorption inhibitory agent or a caking inhibitory agent containing an adhesive composition containing powdery fat/oil. Patent Literature 4 discloses a technique for preventing caking caused by moisture absorption of a powdered food/drink by containing a polyglyceryl fatty acid ester having an HLB value of 5 or less into a powdered food/drink or a raw material thereof.

### PATENT LITERATURES

[Patent Literature 1]JP Hei 10-16122-A

[Patent Literature 2]JP Hei 2-255045-A

[Patent Literature 3]JP 2018-148885-A

[Patent Literature 4]JPWO 2015/182424-A

However, by way of the method recited in Patent Literature 2, the dried powder had a remarkably large surface area, and it was difficult to cover the entire surface with an edible film material or the like. Though the method recited in Patent Literature 3 can be applicable to a powder, the flavor of the adhesive composition containing powder fat/oil per se can affect the flavor of the dried food. Patent Literature 4 teaches that the method recited therein minimizes the organoleptic quality of the powdered food, and it is considered that the flavor of the dried powder is not affected, but it requires additives other than the main food material of the powder food. That is, there is an issue as described above in preventing damping of the dried powder. Damping of the dried powder can cause issues such as deteriorated handling caused by caking of the powder and worsened fluidity, resulting in deterioration in flavor and color tone, and the like.

### SUMMARY

One or more embodiments of the present invention provide a powder of an edible plant which hardly gets damped in a simple manner, without a substance other than a dried edible plant serving as a main food material for imparting features to a flavor and a color tone of a dried powder, and a method for producing the same.

As a result of energetic studies in view of the above circumstances, the present inventors focused on the effect of a non-edible part of edible plants, which is not taught in the conventional art. The present inventors newly found that the above can be easily solved simultaneously by adjusting the shape characteristics of the powder defined by the repose angle and the “loose bulk density/tight bulk density” to certain ranges. Specifically, it was conventionally believed that the smaller value of the repose angle was advantageous in the industry, due to less crosslinking or the like. However, the present inventors intentionally adjusted the repose angle to a specific value or above. In addition, the higher value of the “loose bulk density/tight bulk density” was believed to be industrially advantageous in terms of powder fluidity. The present inventors adjusted the “loose bulk density/tight bulk density” to a level lower than a specific value or below, thereby finding that the powder fluidity was lost, but the powder was more resistant to damping. Then, the present inventors completed the following inventions by further energetic researches on the basis of the above findings.

That is, one or more embodiments of the present invention provide the following [1] to [15].

[1]A dried powder comprising an edible part and a non-edible part of a dried edible plant, satisfying the following conditions (1) to (4):
(1) a proportion of the non-edible part to the edible part of the dried edible plant is 1% by mass or more and 200% by mass or less;
(2) an repose angle is 0.7 rad or more;
(3) “loose bulk density/tight bulk density” is 0.88 or less; and
(4) a moisture content is 20% by mass or less.

[2]The dried powder according to [1], further satisfying (5) :
(5) a content of dietary fiber is 18% by mass or more.

[3]The dried powder according to [1] or [2], further satisfying (6):
(6) d90 after ultrasonication is 2,000 μm or less.

[4]The dried powder according to any one of [1] to [3], further satisfying (7):
(7) “tapped bulk density/tight bulk density” is 0.85 or less.

[5]The dried powder according to any one of [1] to [4 ] comprising the non-edible part of the edible plant in an amount of 1% by mass or more and 90% by mass or less based on the whole dried powder.

[6]The dried powder according to any one of [1] to [5], wherein the edible part and the non-edible part of the edible plant are derived from the same kind of edible plant.

[7]The dried powder according to any one of [1] to [6], wherein the edible part and the non-edible part of the edible plant are derived from the same individual edible plant.

[8]The dried powder according to any one of [1] to [7], wherein the edible plant is one or more selected from the group consisting of cereal, potato, pulse, nut/seed, vegetable, fruit, and mushroom.

[9]The dried powder according to any one of [1] to [8], wherein the edible plant is one or more selected from the group consisting of paprika, beet, soybean, corn, carrot, pumpkin, pea, broad bean, sweet potato, broccoli, spinach, and kale.

[10]The dried powder according to any one of [1] to [9], wherein the dried powder is packaged in a sealed container with no drying agent therein.

[11]The dried powder according to any one of [1] to [10], wherein a content of the dried edible plant is 10% by mass or more based on the whole dried powder.

[12]The dried powder according to any one of [1] to [11], wherein a content of silicon is 1,000 ppm or less.

[13]The dried powder according to any one of [1] to [12], wherein the dried powder is used for human ingestion.

[14]A food and beverage comprising the dried edible plant powder according to any one of [1] to [13].

[15]A method for producing the dried powder according to any one of [1] to [13], comprising subjecting a dried edible plant having a moisture content of 20% by mass or less to grinding.

[16]A method for producing a dried powder, comprising subjecting a dried edible plant having a proportion of a non-edible part to an edible part of 1% by mass or more and 200% by mass or less, and a moisture content of 20% by mass or less to a grinding treatment until an repose angle reaches 0.7 rad or more and “loose bulk density/tight bulk density” reaches 0.88 or less. [17]A method for making a dried powder less damped, comprising subjecting a dried edible plant having a proportion of a non-edible part to an edible part of 1% by mass or more and 200% by mass or less, and a moisture content of 20% by mass or less to a grinding treatment until an repose angle reaches 0.7 rad or more and “loose bulk density/tight bulk density” reaches 0.88 or less.

One or more embodiments of the present invention provide a dried powder of edible plant which hardly gets damped without relying on a substance other than the dried edible plant serving as a main food material for imparting features to a flavor and a color tone of a dried powder, and a method for producing the same.

### DETAILED DESCRIPTION OF THE EMBODIMENTS

Hereinafter, examples of the one or more embodiments of the present invention will be described, but embodiments of the present invention are not limited to these aspects, and can be implemented with any modifications without departing from the gist thereof.

One or more embodiments of the present invention relate to a dried powder comprising an edible part and a non-edible part of a dried edible plant, satisfying the following conditions (1) to (4):
(1) a proportion of the non-edible part to the edible part of the dried edible plant is 1% by mass or more and 200% by mass or less;
(2) a repose angle is 0.7 rad or more;
(3) “loose bulk density/tight bulk density” is 0.88 or less; and
(4) a moisture content is 20% by mass or less.

The edible plant in one or more embodiments of the present invention is not limited at all as long as the edible part is used for eating, and examples thereof include cereal, potato, pulse, nut/seed, vegetable, fruit, mushroom, alga, and spice. Above all, cereal, potato, pulse, nut/seed, vegetable, fruit, and mushroom are preferred. These foodstuffs may be used alone or two or more in any combination. These foodstuffs may be used as they are, or may be used after being subjected to various treatments (for example, drying, heating, removal of harshness, peeling, removal of seeds, afterripening, salting, and processing of fruit peels). The classification of the foodstuff can be determined from the state of the whole plant combined with the non-edible part.

Examples of cereals include, but are not limited to, corn (in particular, sweetcorn is preferred), rice, common wheat, barley, sorghum, common oat, triticale, rye, buckwheat, fonio, quinoa, Japanese barnyard millet, foxtail millet, proso millet, giant corn, sugar cane, and amaranth. Above all, corn (in particular, sweetcorn is preferred), giant corn, and the like are preferred.

Examples of potatoes include, but are not limited to, sweet potato, cassava, yacon, taro, satoimo, konjac, tashiroimo (Polynesian arrowroot), potato, purple sweet potato, Jerusalem-artichoke, katakuri, yam, Japanese yam, Chinese yam, and kudzu. Above all, purple sweet potato, sweet potato, and the like are particularly preferred.

Examples of pulses include, but are not limited to, common bean, kidney bean, red common bean, white common bean, black bean, pinto bean, toramame, lima bean, scarlet runner bean, pea (in particular, green pea which is an unripe seed obtained by harvesting the seed with pods in an unripe state and whose bean exhibits a green appearance), pigeon pea, mung bean, cowpea, adzuki bean, broad bean, soybean (in particular, green soybean which is an unripe seed obtained by harvesting the soybean with pods in an unripe state and whose bean exhibits a green appearance), chickpea, lentil (Lens esculenta), lentil (Lens culinaris), lentil, peanut, lupin bean, grass pea, locust bean (carob), petai bean, African locust bean, coffee bean, cocoa bean, and Mexican jumping bean. Some of the foodstuffs in which the edible part (for example, green soybean and green pea) are handled as a vegetable can be determined from the state of the whole plant (for example, soybean and pea) combined with the non-edible part (for example, pod) whether the foodstuff belongs to beans. Above all, pea (in particular, green pea which is an unripe seed), soybean (in particular, green soybean which is an unripe seed), broad bean, and the like are preferred.

Examples of nuts/seeds include, but are not limited to, almond, cashew, pecan nut, macadamia nut, pistachio, hazel nut, coconut, pine nut, sunflower seed, pumpkin seed, watermelon seed, chinquapin, walnut, chestnuts, ginkgo, sesame, and Brazil nut. Above all, almond, cashew, macadamia nut, pistachio, hazel nut, coconut, and the like are preferred.

Examples of vegetables include, but are not limited to, Japanese radish, carrot, rutabaga, parsnip, turnip, black salsify, east Indian lotus, beet (suitably table beet (beetroot): a breed improved to use the root of beet for food), arrowhead, eschalot, garlic, rakkyo, lily, kale, onion, asparagus, udo, cabbage, head lettuce, spinach, heading Chinese cabbage, turnip rape, spinach mustard, green bok choy, Chinese chive, Welsh onions, nozawana, Japanese butterbur, chard (fudanso, Swiss chard), mizuna, tomato, eggplant, pumpkin, sweet pepper, cucumber, Japanese ginger, cauliflower, broccoli, edible chrysanthemum, bitter melon, okra, globe artichoke, zucchini, sugar beet, tigernut, ginger, perilla, wasabi, paprika, herbs (watercress, coriander, water morning glory, celery, tarragon, chives, chervil, sage, thyme, laurel, parsley, mustard greens (karashina), Japanese wormwood, basil, oregano, rosemary, peppermint, savory, lemongrass, dill, wasabi leaf, Japanese pepper leaf, and stevia), bracken fern, Japanese royal fern, kudzu, and moso bamboo. Above all, carrot, pumpkin, tomato, paprika, cabbage, beet (suitably table beet (beetroot)), onion, broccoli, asparagus, spinach, kale, and the like are preferred, and carrot, pumpkin, paprika, beet (suitably table beet (beetroot)), broccoli, spinach, kale, and the like are particularly preferred.

Examples of fruits include, but are not limited to, Chinese quince, Chinese white pear (white pear, Chinese pear), nashi pear, common quince, medlar, juneberry, shipova, apple, American cherry (black cherry, dark cherry), apricot, Mume, cherry (sweet cherry), sour cherry, blackthorn, Japanese plum, peach, ginkgo, chestnuts, akebia, fig, Japanese persimmon, cassis (blackcurrant), bramble, kiwifruit (kiwi), gummy, mulberry (dodome), cranberry (American cranberry), cowberry (iwamomo, hamanashi, okamaringo), pomegranate, Hardy kiwi (shirakuchizuru, kokuwa), sea buckthorn (saji, hippophae, seaberries), gooseberry, jujube, Japanese bush cherry (koume, ikuri), haskap (honeyberry), bilberry, redcurrant, grape, blackberry, blueberry, pawpaw, matsubusa, raspberry, downy cherry, mandarin orange, kumquat, trifoliate orange, olive, loquat, red bayberry, monkfruit, tropical fruits (tropical fruits such as mango, mangosteen, papaya, cherimoya, atemoya, banana, durian, carambola, guava, pineapple, acerola, passion fruit, pitaya, lychee, and canistel), strawberry, watermelon, melon, avocado, miracle fruit, orange, lemon, prune, yuzu, sudachi, grapefruit, bitter orange, and flat lemon.

Examples of mushrooms include, but are not limited to, shiitake mushroom, matsutake, Jew's ear, maitake, sarunokoshikake, oyster mushroom, King oyster mushroom, enokitake, shimeji, naratake, mushroom, nameko, Jersey cow mushroom, hatsutake, and chichitake.

Examples of algae include, but are not limited to, macroalgae such as kombu, wakame, nori, green laver, and tengusa; and microalgae such as green algae, red algae, blue-green algae, dinoflagellate, and Euglena. Specific examples thereof include, sea lettuce, green laver, perforated sea lettuce, sea grapes (green caviar), katashiokusa, green caviar, kuromiru, tamamiru, torinoashi (yuikiri), hitoegusa, hiraaonori, fusaiwazuta, grass kelp, akamoku, amijigusa, arame, antokume, ishige, ichimegasa, iroro, iwahige, umitoranoo, sea fan, oobamoku, Okinawa-mozuku, kaigaraamanori, kagomenori, kajime (arame), kayamonori, gibasa (akamoku, ginbaso, jinbaso, jibasa), sanadagusa, shiwanokawa, shiwayahazu, seiyo habanori, tsuruarame, nanori (kayamonori), nebarimo, nokogirimoku, habanori, hijiki, hirome, fukuronori, futomozuku, hondawara, ma-kombu, matsumo, mugiwaranori (kayamonori), muchimo, moduku (mozuku), yuna, wakame, Asakusa nori, ibotsunomata, ushikenori, usukawakaninote, ezotsunomata (kurohaginnanso), oobusa, ogonori, okitsunori, obakusa, katanori, kabanori, kamogashiranori, kijinoo, kurohaginnanso (ezotsunomata), sakuranori, shiramo, tanbanori, tsunomata, tsurushiramo, tsurutsuru, tosakanori, tosakamatsu, nogenori (fukuro funori), nori (susabinori), hanafunori, harigane, hiragaragara, hirakusa, hiramukade, pirihiba, fukuro funori, fushitsunagi, makusa, maruba amanori, mitsudesozo, euglena, chlorella, mirin, mukadenori, yuikiri, yukari, and tengusa. Among these algae, some of microalgae such as chlorella have a significantly strong cell wall, and thus, it is preferred to utilize microalgae after being subjected to a pretreatment to disrupt the cell wall, or use algae other than microalgae.

Examples of spices include, but are not limited to, white pepper, red pepper, chili, horseradish, mustard, poppy seed, nutmeg, cinnamon, cardamon, cumin, saffron, allspice, clove, sansho, orange peel, fennel, licorice, fenugreek, dill seed, Chinese pepper, long pepper, and olive fruit.

In the present disclosure, the “non-edible part” of the edible plant refers to the part of the edible plant which is usually not suitable for drinking and eating or the part which is to be discarded in usual dietary habits, and the “edible part” refers to the part excluding the disposal site (non-edible part) from the whole edible plant. Particularly for the edible plant containing a thick dietary fiber layer, a trichome, or the like, these parts are not available for eating and often discarded due to bad feeding performance and bad compatibility with other food products. In one or more embodiments of the present invention, the non-edible part containing such a thick dietary fiber layer, a trichome, or the like can be suitably used.

In the edible plant used for one or more embodiments of the present invention, the edible part and the non-edible part thereof may be derived from different kinds of edible plants, but it is preferred to contain the edible part and the non-edible part derived from the same kind of edible plant from the viewpoint the uniformity of flavor. Further, it is preferred to contain the edible part and the non-edible part derived from the same edible plant individual. That is, such an edible plant can be effectively utilized by using a part or the whole of the edible part and a part or the whole of the non-edible part each derived from the same edible plant individual.

Examples of the non-edible part of the edible plant include skin, seed, core, and draff of the various edible plants described above. Above all, since rich nutrients remain in the skin, seed, core, draff, and the like of, without limitation, corn (for example, sweetcorn), paprika, pumpkin, table beet, broccoli, spinach, carrot, kale, green soybean, pea, broad bean, sweet potato, tomato, rice, onion, cabbage, apple, grape, sugar cane, citrus fruits (for example, satsuma mandarin and yuzu), they can be suitably used in one or more embodiments of the present invention. Specific examples of the non-edible part of the edible plant include, but are not limited to, bract or pistil or cob of corn (for example, sweetcorn); stem end or core or seed of paprika; pith or seed or both ends of pumpkin; root tip or skin or petiole of table beet; leaf and stem of broccoli; plant foot of spinach; root tip or petiole base of carrot; petiole base of kale; pod of green soybean; pod of pea; seed skin or pod of broad bean; surface skin and both ends of sweet potato; stem end of tomato; rice hull of rice (unhulled rice); skin (protective leaf), bottom part, or head part of onion; core of cabbage; core of apple; fruit peel and seed of grape; draff of sugar cane; and peel, seed, and pith of citrus fruits (for example, satsuma mandarin and yuzu). One not containing any components harmful to the human body in a degree that affects the human body is preferably used.

The site or the ratio of the non-edible part in the edible plant used in one or more embodiments of the present invention could be of course understood by those skilled in the art of handling the food product or the processed product of the food product. For example, the “disposal site” and the “disposal ratio” described in the Standard Tables of Food Composition in Japan 2015 (Seventh Revised Edition) can be referenced and respectively treated as the site and the ratio of the non-edible part. The following Table 1 lists examples of the edible plant and the “disposal site” and the “disposal ratio” (that is, the site and the ratio of the non-edible part) described in the Standard Tables of Food Composition in Japan 2015 (Seventh Revised Edition) with respect to the edible plant.

TABLE 1

| | Site of non- | Ratio of non- |
|---|---|---|
| | edible part | edible part |
| Edible plant | (disposal site) | (disposal ratio) |
| Vegetables/green soybean/raw | Pod | 45% |
| Vegetables/(corns)/sweetcorn/immature | Bract, pistil, | 50% |
| seed, raw | and cob | |
| Vegetables/(pumpkins and squashes)/ | Pith, seed, | 9% |
| Japanese pumpkin/fruit, raw | and both ends | |
| Vegetables/(sweet peppers)/red sweet | Stem end, core, | 10% |
| pepper/fruit, raw (paprika) | and seed | |
| Vegetables/table beet/root, raw | Root tip, skin, | 10% |
| | and petiole | |
| Vegetables/broccoli/inflorescence, raw | Leaf and stem | 50% |
| Vegetables/(tomatoes)/tomato/fruit, raw | Stem end | 3% |
| Vegetables/(cabbages)/cabbage/ | Core | 15% |
| head-forming leaf, raw | | |
| Vegetables/spinach/leaf, raw | Plant foot | 10% |
| Vegetables/kale/leaf, raw | Petiole base | 3% |
| Vegetables/(peas)/green pea/raw | Pod | 55% |
| Vegetables/broad bean/immature | Seed coat, pod | 80% |
| bean/raw | | |
| Vegetables/(carrots)/root, with | Root tip and | 3% |
| skin, raw | petiole base | |
| Potatoes and starches/sweet potato/ | Surface skin | 10% |
| tuberous root, raw | and both ends | |

The dried edible plant in one or more embodiments of the present invention may be prepared by subjecting various edible plants described above to drying. Any method commonly used in the drying of the food product can be used as a drying method. Examples thereof include sun drying, shade drying, freeze drying, air drying (for example, hot air drying, fluid bed drying, spray drying, drum drying, and low-temperature drying), pressure drying, reduced-pressure drying, microwave drying, and oil heat drying. Above all, an air drying method (for example, hot air drying, fluid bed drying, spray drying, drum drying, and low-temperature drying) or a freeze drying method is preferred in view of small degree in the change of the inherent color tone and the flavor of the foodstuff and controllability of the fragrance (such as a burning smell) other than the food product.

The ‘dried’ state in the present disclosure refers to a state where the moisture content is about 20% by mass or less, the water activity value is 0.85 or less. In addition, the moisture content may be 15% by mass or less, or 10% by mass or less. Further, the water activity value may be 0.80 or less, or 0.75 or less. Measurements are carried out in accordance with a method for subjecting the dried powder to a reduced-pressure heat-drying method as a method for quantifying water content and a known method using an ordinary water activity measuring apparatus as a method for measuring water activity value.

The dried powder in one or more embodiments of the present invention contains the edible part and the non-edible part of the dried edible plant and the lower limit value of the proportion of the non-edible part to the edible part of the dried edible plant is only required to be 1% by mass or more from the viewpoint of achieving the effect of one or more embodiments of the present invention, and it may be 3% by mass or more, 10% by mass or more, or 20% by mass or more. On the other hand, the upper limit value may be 200% by mass or less, 150% by mass or less, or 100% by mass or less from the viewpoint of a non-preferred flavor such as acrid taste derived from the non-edible part.

As described above, mixing of the non-edible part of the dried edible plant with the edible part in predetermined amounts allows the dried powder of one or more embodiments of the present invention to have a particular particle structure and shape defined by the repose angle of the particles and the “loose bulk density/tight bulk density” due to fiber characteristics of the non-edible part so that powder having favorable drying properties which is less likely to be damped is obtained. As described above, the flowability of the dried powder is lost by mixing the non-edible part of the dried edible plant with the edible part in predetermined amounts, but as a result, an effect of increasing re-drying properties of the powder is achieved and a powder having favorable drying properties which is less likely to be damped is obtained.

It is known as common knowledge that a silicon compound contained in the soil improves the flowability of the dried powder, when a site having many opportunities to come in contact with the soil (the non-edible part such as the skin or pod of a food product or the edible part exposed to the outside) is used. Thus, it is desired not to contain the silicon from the soil if possible so that the effect of one or more embodiments of the present invention can be achieved by not improving the flowability and the dried powder may have a quality suitable for human ingestion from the viewpoint of safety and security. Specifically, the silicon content in the dried powder may be 1,000 ppm or less, 800 ppm or less, 600 ppm or less, 400 ppm or less, 200 ppm or less, or 100 ppm or less. Specifically, the number of viable cells after drying may be adjusted to be 10⁶ cells/g or less because the composition may have a quality suitable for human ingestion, or adjusted to be 10³ cells/g or less.

The repose angle refers to a maximum angle of a slope where the powder remains stable without being spontaneously collapsed when the powder is stacked, and it is determined depending on the particle size and the roundness or the shape of particles. While a discharge method, a drop weight method, an injection method, and a tilting method are known as the method for measuring the repose angle, the repose angle is measured by an injection method in which injection is made into a fixed circular plate with a holding edge for holding the dried powder.

More specifically, the dried powder is stacked by an injection method to form a symmetry, approximately conical laminate on a fixed circular plate having a radius r (cm) with a holding edge for holding the dried powder, and then a height H (cm) which is the difference between the highest portion of the holding edge and the highest portion of the approximately conical laminate is measured, and this allows the “repose angle α(°)” to be determined from “tangα=H/r” and allows the repose angle to be calculated as “repose angle (rad)”=“α×π/180”. Specifically, a value measured at a condition of r=1.75 cm can be adopted. In the dried powder of one or more embodiments of the present invention, the flowability of the particles is lost by adjusting the repose angle to 0.7 rad or more, but as a result, an effect of enhancing re-drying properties is achieved. Above all, the repose angle may be 0.8 rad or more, 0.9 rad or more, or 1.0 rad or more. The upper limit of the repose angle may be 1.3 rad or less, or 1.2 rad or less from the viewpoint of flowability of the dried powder. The repose angle is enhanced by containing the non-edible part of a plant.

The “loose bulk density/tight bulk density” of powder is an indication of the compressibility of powder and determined depending on the particle size and the shape. The loose bulk density is an apparent density when powder is gently filled into a container without compaction and represents a ratio of the mass of a powder sample in an untapped (loose) state to the volume of the powder containing a factor of the interparticle void volume. Therefore, the bulk density depends on the particle density of powder and the spatial arrangement (for example, the shape) of particles in a powder layer.

The tight bulk density is also referred to as a press density and is an apparent density obtained by pressing powder into a container until the volume of the powder no longer changes (in one or more embodiments of the present invention, under a pressure of 0.6 MPa) and then compressing the powder. It is measured by, for example, pressing a plunger until the volume of the powder no longer changes (for example, at a force of 5 kgf) using a plastic syringe (LS disposal syringe 2 mL: maximum memory: 3 mL, level full volume: 4.0 mL, inside diameter: 1 cm) which is closed to the extent not causing dropping of the powder while securing the permeability of the cylindrical tip. In the dried powder of one or more embodiments of the present invention, the flowability of the particles is lost by adjusting the “loose bulk density/tight bulk density” to 0.88 or less, but as a result, free water is likely to be released from the particles and an effect of enhancing re-drying properties is achieved. Above all, the “loose bulk density/tight bulk density” may be 0.85 or less, 0.80 or less, or 0.75 or less. The lower limit of the “loose bulk density/tight bulk density” may be 0.15 or more, or 0.25 or more. The “loose bulk density/tight bulk density” is reduced by containing the non-edible part of a plant.

Further, in the dried powder of one or more embodiments of the present invention, the “tapped bulk density/tight bulk density of powder” may be 0.85 or less, 0.80 or less, or 0.75 or less because the dried powder may have a quality which makes drying easy. The lower limit of the “loose bulk density/tight bulk density” may be 0.15 or more, or 0.25 or more. The tapped bulk density refers to an apparent density at the time of tap filling and it is measured by injecting powder up to the level full volume while tapping.

The dried powder of one or more embodiments of the present invention may contain 18% by mass or more of the dietary fiber. Above all, the content of the dietary fiber may be 20% by mass or more, 22% by mass or more, or 25% by mass or more from the viewpoint of achieving the effect of one or more embodiments of the present invention. The upper limit of the content of the dietary fiber may be 60% by mass or less, 50% by mass or less, or 40% by mass or less. As used herein, the dietary fiber refers to the total amount of water-soluble dietary fiber and insoluble dietary fiber, but the dietary fiber to be contained may be the insoluble dietary fiber. The content of the insoluble dietary fiber may be 70% by mass or more based on the total amount of the water-soluble dietary fiber and the insoluble dietary fiber.

A method typically used to measure components of a food product can be used to measure the total amount of the dietary fiber and the insoluble dietary fiber, and for example, a measuring method in accordance with the method described in the Standard Tables of Food Composition in Japan can be used. Specifically, a method for subjecting the dried powder to the modified Prosky method is used as a method for quantifying the dietary fiber in a food product and insoluble dietary fiber.

In the dried powder of one or more embodiments of the present invention, the upper limit of d90 after ultrasonication (90% cumulative particle size of a particle size) may be 2,000 μm or less. However, the upper limit may be 1,800 μm or less, 1,600 μm or less, 1,400 μm or less, 1,200 μm or less, 1,000 μm or less, 900 μm or less, 800 μm or less, 700 μm or less, or 600 μm or less, from the viewpoint of improving drying properties. The lower limit is not particularly limited, but may be 30 μm or more, or 100 μm or more from the viewpoint of handleability. In one or more embodiments of the present invention, “ultrasonication” represents, unless otherwise specified, a treatment of applying an ultrasonic wave having a frequency of 40 kHz to a measurement sample with an output of 40 W for 3 minutes.

The particle size d90 of the dried powder is defined as the particle size at which, when the particle size distribution of the dried powder is divided into two from a certain particle size, the ratio of the proportion of the cumulative value of the % particle frequency on the large side to the proportion of the cumulative value of the % particle frequency on the small side is 10:90. The particle size d90 of the dried powder can be measured, for example, using a laser diffraction particle size distribution measuring apparatus described below. As used herein, the “particle size” represents particle sizes all measured on the volumetric basis, unless otherwise specified.

d50 after ultrasonication of the dried powder in one or more embodiments of the present invention (it is defined as the particle size at which, when the particle size distribution of the dried powder is divided into two from a certain particle size, the ratio of the proportion of the cumulative value of the % particle frequency on the large side to the proportion of the cumulative value of the % particle frequency on the small side is 50:50) may be 800 μm or less, 700 μm or less, or 600 μm or less. On the other hand, the lower limit thereof is not particularly limited, but may be 10 μm or more, or 50 μm or more, from the viewpoint of handleability. Regarding the measurement method, the measurement is carried out in the same manner as d90 after ultrasonication.

The measurement conditions of the particle size of the dried powder of one or more embodiments of the present invention are not limited, but the following conditions can be used. First, as the solvent for the measurement, ethanol is used because it hardly affects the structure of the dried powder of the dried edible plant. The laser diffraction particle size distribution measuring apparatus used for the measurement is not limited, but for example, the Microtrac MT3300 EXII system of MicrotracBEL Corp. can be used. The measurement application software is not limited, but for example, the DMS2 (Data Management System version 2, MicrotracBEL Corp.) can be used. When the aforementioned measuring apparatus and software are used, it is only required for the measurement to press the cleaning button of the software to conduct cleaning, followed by pressing the Set zero button of the software to conduct zero adjustments, and directly charging the sample until the concentration becomes within an appropriate range by sample loading. When the sample after agitation, that is, the sample having been subjected to ultrasonication is measured, the sample having been subjected to ultrasonication in advance may be charged, or ultrasonication may be performed using the aforementioned measuring apparatus after charging the sample, and subsequently, the measurement may be performed. In this case, after the sample not being subjected to ultrasonication is charged into the apparatus and the concentration is adjusted within the appropriate range by sample loading, the ultrasonication button of the software is pressed to perform ultrasonication. Thereafter, a degassing treatment is performed three times and the sample loading process is performed again. After it is confirmed that the concentration is still within the appropriate range, a laser diffraction measurement at a flow velocity of 60% and at a measurement time of 10 seconds is performed and the result can be determined as a measurement value. The parameter for the measurement is, for example, distribution display: volume, refractive index of particle: 1.60, refractive index of solvent: 1.36, measuring upper limit (μm)=2,000.00 μm, and measuring lower limit (μm)=0.021 μm.

When the particle size of the dried powder in one or more embodiments of the present invention is determined, it is preferred that the particle size distribution for each channel (CH) be measured at first and then the particle size for each channel described in Table 2 below be used as the standard. Specifically, the % particle frequency for each channel (also referred to as “the % particle frequency of channel **”) can be determined by measuring the frequency of particles whose particle size is not more than the particle size defined for each channel in Table 2 below and larger than the particle size defined for the channel having one higher number (in the largest channel within the measuring range, a particle size at the measuring lower limit) for each channel in Table 2 below, and using the total frequency of all channels within the measuring range as a denominator. For example, the % particle frequency of channel 1 represents the % frequency of particles having a particle size of 2,000.00 μm or less and larger than 1,826.00 μm.

TABLE 2

| Channel | Particle diameter (μm) |
|---|---|
| 1 | 2000.000 |
| 2 | 1826.000 |
| 3 | 1674.000 |
| 4 | 1535.000 |
| 5 | 1408.000 |
| 6 | 1291.000 |
| 7 | 1184.000 |
| 8 | 1086.000 |
| 9 | 995.600 |
| 10 | 913.000 |
| 11 | 837.200 |
| 12 | 767.700 |
| 13 | 704.000 |
| 14 | 645.600 |
| 15 | 592.000 |
| 16 | 542.900 |
| 17 | 497.800 |
| 18 | 456.500 |
| 19 | 418.600 |
| 20 | 383.900 |
| 21 | 352.000 |
| 22 | 322.800 |
| 23 | 296.000 |
| 24 | 271.400 |
| 25 | 248.900 |
| 26 | 228.200 |
| 27 | 209.300 |
| 28 | 191.900 |
| 29 | 176.000 |
| 30 | 161.400 |
| 31 | 148.000 |
| 32 | 135.700 |
| 33 | 124.500 |
| 34 | 114.100 |
| 35 | 104.700 |
| 36 | 95.960 |
| 37 | 88.000 |
| 38 | 80.700 |
| 39 | 74.000 |
| 40 | 67.680 |
| 41 | 62.230 |
| 42 | 57.060 |
| 43 | 52.330 |
| 44 | 47.980 |
| 45 | 44.000 |
| 46 | 40.350 |
| 47 | 37.000 |
| 48 | 33.930 |
| 49 | 31.110 |
| 50 | 28.530 |
| 51 | 26.160 |
| 52 | 23.990 |
| 53 | 22.000 |
| 54 | 20.170 |
| 55 | 18.500 |
| 56 | 16.960 |
| 57 | 15.560 |
| 58 | 14.270 |
| 59 | 13.080 |
| 60 | 12.000 |
| 61 | 11.000 |
| 62 | 10.090 |
| 63 | 9.250 |
| 64 | 8.482 |
| 65 | 7.778 |
| 66 | 7.133 |
| 67 | 6.541 |
| 68 | 5.998 |
| 69 | 5.500 |
| 70 | 5.044 |
| 71 | 4.625 |
| 72 | 4.241 |
| 73 | 3.889 |
| 74 | 3.566 |
| 75 | 3.270 |
| 76 | 2.999 |
| 77 | 2.750 |
| 78 | 2.522 |
| 79 | 2.312 |
| 80 | 2.121 |
| 81 | 1.945 |
| 82 | 1.783 |
| 83 | 1.635 |
| 84 | 1.499 |
| 85 | 1.375 |
| 86 | 1.261 |
| 87 | 1.156 |
| 88 | 1.060 |
| 89 | 0.972 |
| 90 | 0.692 |
| 91 | 0.818 |
| 92 | 0.750 |
| 93 | 0.688 |
| 94 | 0.630 |
| 95 | 0.578 |
| 96 | 0.530 |
| 97 | 0.468 |
| 98 | 0.446 |
| 99 | 0.409 |
| 100 | 0.375 |
| 101 | 0.344 |
| 102 | 0.315 |
| 103 | 0.289 |
| 104 | 0.265 |
| 105 | 0.243 |
| 106 | 0.223 |
| 107 | 0.204 |
| 108 | 0.187 |
| 109 | 0.172 |
| 110 | 0.158 |
| 111 | 0.145 |
| 112 | 0.133 |
| 113 | 0.122 |
| 114 | 0.111 |
| 115 | 0.102 |
| 116 | 0.094 |
| 117 | 0.086 |
| 118 | 0.079 |
| 119 | 0.072 |
| 120 | 0.066 |
| 121 | 0.061 |
| 122 | 0.056 |
| 123 | 0.051 |
| 124 | 0.047 |
| 125 | 0.043 |
| 126 | 0.039 |
| 127 | 0.036 |
| 128 | 0.033 |
| 129 | 0.030 |
| 130 | 0.028 |
| 131 | 0.026 |
| 132 | 0.023 |

In the dried powder of one or more embodiments of the present invention, in order to adjust the dried edible plant such that d90 after ultrasonication (90% cumulative particle size of a particle size) may be 2,000 μm or less, any of a method of drying the edible part and/or the non-edible part of the edible plant and then subjecting it to a finely pulverizing treatment, or a method of drying the edible part and/or the non-edible part being subjected to a finely pulverizing treatment, or a combination thereof may be used. The same applies to d50 after ultrasonication.

The means for finely pulverizing treatment used in one or more embodiments of the present invention is not particularly limited. The temperature at the time of finely pulverizing is not limited and any of high-temperature grinding, normal-temperature grinding, and low-temperature grinding may be used. The pressure at the time of finely pulverizing is also not limited and any of high-pressure grinding, normal-pressure grinding, and low-pressure grinding may be used. However, it is preferred to use a means which allows to treat the foodstuff and other components, which are materials of the composition, with high shear forces under pressure and elevated temperature conditions in a short time from the viewpoint of effectively obtaining a dried edible plant powder. Examples of the apparatus for such a finely pulverizing treatment include instruments such as a blender, a mixer, a mill, a kneader, a grinder, a pulverizer, and an attritor, but any of which may be used. For the apparatus thereof, for example, a medium agitation mill such as a dry bead mill and a ball mill (such as tumbling and vibrating), a jet mill, a high-speed rotation impact mill (such as a pin mill), a roll mill, a hammer mill, and the like can be used.

The dried powder of one or more embodiments of the present invention may be packaged in a sealed container when distributed as a product, but since having a moisture absorption-suppressing effect (being less likely to be damped) as described above, it is preferred not to enclose any drying agent which may cause contamination. The material or the shape of the sealed container is not limited at all.

In one or more embodiments of the present invention, the lower limit of the content of the non-edible part of the edible plant based on the whole dried powder is only required to be 1% by mass or more. Above all, it may be 2.5% by mass or more, 3% by mass or more, 5% by mass or more, 7% by mass or more, or 9% by mass or more from the viewpoint of improving re-drying properties. On the other hand, the upper limit is only required to be 90% by mass or less, but above all, it may be 80% by mass or less, 70% by mass or less, or 60% by mass or less from the viewpoint of taste. This seems to be derived from the effect of the non-edible part of the edible plant which contains a large amount of insoluble dietary fiber, but the detailed reason thereof is unclear.

Furthermore, when the total content of the edible part and the non-edible part of the dried edible plant based on the whole dried powder is in a predetermined range in one or more embodiments of the present invention, characteristics (an effect of making the dried powder less likely to be damped) are dominantly exerted over the whole dried powder. For example, the total content of the edible part and the non-edible part of the dried edible plant based on the whole powder is only required to be 10% by mass or more, and above all, it may be 30% by mass or more, 50% by mass or more, 70% by mass or more, 90% by mass or more, or 100% by mass from the viewpoint of efficacy of the effect. The kind of other dried powder other than when the content of the dried edible plant based on the whole powder is 100% by mass is not limited at all, as long as the powder does not prevent the effect of one or more embodiments of the present invention. If it is a food material in a dried powder state, foodstuffs can be appropriately selected in accordance with the desired flavor and quality for the final dried powder, without being limited by the kind of foodstuffs, the combination of kinds thereof, and the application.

One or more embodiments of the present invention also relate to a method for producing dried powder by subjecting the dried edible plant having a proportion of the non-edible part to the edible part of 1% by mass or more and 200% by mass or less and a moisture content of 20% by mass or less to grinding until the repose angle reaches 0.7 rad or more and the “loose bulk density/tight bulk density” reaches 0.88 or less. Details are as described above.

One or more embodiments of the present invention also relate to a method for making the dried powder less likely to be damped by subjecting the dried edible plant having a proportion of the non-edible part to the edible part of 1% by mass or more and 200% by mass or less and a moisture content of 20% by mass or less to a finely pulverizing treatment until the repose angle reaches 0.7 rad or more and the “loose bulk density/tight bulk density” reaches 0.88 or less. Details are as described above.

One or more embodiments of the present invention also relate to a food and beverage containing the dried edible plant powder of one or more embodiments of the present invention. The amount of the dried edible plant powder of one or more embodiments of the present invention blended into the food and beverage to be added is not particularly limited and only required to be appropriately adjusted so that the flavor of the edible plant as the raw material of the dried edible plant powder can be imparted to the food and beverage. The proportion of the edible plant powder based on the total amount of the food and beverage may be 10% by mass or more, 20% by mass or more, 30% by mass or more, or 40% by mass or more, based on the proportion of dry weight. The upper limit may be 100% by mass or less.

The food and beverage of one or more embodiments of the present invention are not limited at all and the form thereof may be any of a liquid form, a semi-solid form, or a solid form. Examples of the kind of the food and beverage include a liquid food product such as beverage (for example, soup and smoothie), food and beverage in a liquid, semi-solid or solid form such as seasonings (for example, mayonnaise, dressing, butter, and margarine), a semi-solid or solid food such as confectioneries (for example, granola, stick, cracker, caramel, gummy, and chips), and a powder food product such as dry seasonings, and above all, a powder food product is preferred from the viewpoint of more significantly achieving the effect of one or more embodiments of the present invention.

### EXAMPLES

Hereinafter, one or more embodiments of the present invention will be described in further detail with reference to Examples, but these Examples are illustrative only for the purpose of the explanation, and embodiments of the present invention are not limited to these Examples in any way.

### Preparation of Dried Edible Plant Sample

Dried edible plants of Comparative Examples 1 to 10 and Test Examples 1 to 16 were prepared as follows.

Sweetcorn, beetroot, carrot, pumpkin, paprika, and sweet potato were respectively separated into the edible part and the non-edible part and finely cut. In addition, pea (edible part: green pea, non-edible part: pod) and soybean (edible part: green soybean, non-edible part: pod) were boiled and beans which were removed from the pod and dried were separated into the edible part, and other parts (pod) were separated into the non-edible part, and each of them was finely cut. Then, each of them was dried using a forced-air dryer (Electric Dehydrator DSK-10 manufactured by Shizuoka Seiki Co., Ltd.) at an ambient temperature of 70° C. All the dried materials were subjected to a drying treatment until the moisture content reached 20% by mass. These were subjected to a fine grinding using a mill (Wonder Crusher WC-3, purchased from OSAKA CHEMICAL Co., Ltd.). Thereafter, each of the edible part and the non-edible part of the edible plant was mixed in the proportions shown in Table 3 and Table 4 and homogenized.

The dietary fiber, repose angle, “loose bulk density/tight bulk density”, and d90 and d50 after ultrasonication of these dried edible plants were measured. Specific methods of measurement were as described above. The dietary fiber was measured by a Modified Prosky Method; the repose angle was measured by an injection method in which injection is made into a fixed circular plate (r=1.75 cm) with a holding edge; regarding the “loose bulk density/tight bulk density”, the loose bulk density is measured by directly injecting powder in a plastic syringe (LS disposal syringe 2 mL: maximum memory: 3 mL, level full volume: 4.0 mL, inside diameter: 1 cm) up to the level full volume in which the plastic syringe is closed to the extent not causing dropping of the powder while securing the permeability of the cylindrical tip, and a tapped bulk density was measured by injecting the powder into a syringe up to the level full volume while tapping until the volume of the powder in the syringe no longer changes, and the tight bulk density was measured by pressing a plunger at a force of 5 kgf until the volume of the powder in the syringe no longer changed and then thereby compressing the powder under a pressure of 0.6 MPa. d90 after ultrasonication was measured by using the Microtrac MT3300 EXII system of MicrotracBEL Corp. as a laser diffraction particle size distribution measuring apparatus, the DMS2 (Data Management System version 2, MicrotracBEL Corp.) as a measurement application software, and ethanol as a solvent.

Then, after 50% by mass of water was added to each of the powder adjusted as described above, each mixture was allowed to stand in an atmosphere of 70° C. and dried. The ease of drying of the powder (re-drying properties) was evaluated by measuring the time required for drying until the moisture content reached 10% by mass. For the evaluation criteria, the evaluation was carried out based on the five grades: 5: easily re-dried and preferred, 4: slightly easily re-dried and slightly preferred, 3: neither preferred nor unpreferred, 2: slightly less easily re-dried and slightly unpreferred, 1: less easily re-dried and unpreferred. For example, when 5 g of water is added to 10 g of powder (the moisture content of 10% by mass), static drying of the mixture was then performed in an atmosphere of 70° C. As a result, when it takes 60 minutes until the weight after drying reaches 10 g, the time required for drying until the moisture content reaches 10% by mass is 60 minutes. When static drying is performed, any typical forced-air drying apparatus can be used.

Furthermore, the evaluation was carried out for the resistance to dampness of each powder. A typical thermo-hygrostat (KCL-2000A, manufactured by TOKYO RIKAKIKAI CO, LTD.) was used, the relative humidity of the air in the apparatus was adjusted to about 75 Rh %, and about 1 g of powder was allowed to stand in a container in an atmosphere of 20° C. for about 30 days, and thereafter, the flavor, appearance, and physical properties were observed as a quality of the powder. For the evaluation criteria, the evaluation was carried out based on the five grades: 5: change in quality is small before and after storage and preferred, 4: change in quality is slightly small before and after storage and slightly preferred, 3: quality changes as compared with the quality before storage but within the acceptable range, 2: change in quality is slightly outstanding before and after storage and slightly unpreferred, 1: change in quality is outstanding before and after storage and unpreferred.

Training of the following A) to C) were conducted for sensory test panelists, and panelists who have particularly excellent results in the training, product development experience, and a wide variety of knowledge about the quality such as the taste and texture of food products, and can perform an absolute evaluation on each sensory evaluation item, were selected.

A) Quality of taste discrimination test in which, for five basic tastes (sweet: taste of sugar, sour: taste of tartaric acid, umami: taste of sodium glutamate, salty: taste of sodium chloride, bitter: taste of caffeine), one aqueous solution having a concentration close to the threshold of each component is prepared for respective components and two distilled water are added to make a total of seven samples, and from which the sample of each taste is accurately discriminated.

B) Concentration discrimination test in which concentration differences in five kinds of saline solutions and acetic acid aqueous solutions each having slightly different concentrations are accurately discriminated.

C) Three-item discrimination test in which, two soy sauces from manufacturer A and one soy sauce from manufacturer B are provided and among a total of three samples, the soy sauce from B is accurately discriminated.

For every evaluation item as mentioned above, the evaluation of the standard sample was performed by all panelists in advance and the evaluation criteria for each score were standardized, and then the objective sensory test was performed by ten panelists. The evaluation of each evaluation item was evaluated by a method, in which each panelist selected any one number closest to the evaluation by the panelist from the 5-point scale for each item. The evaluation results were summarized by calculating the arithmetic mean value from the scores of ten panelists.

The results are shown in Table 3 and Table 4.

TABLE 3

| | | | Proportion | | | | | |
|---|---|---|---|---|---|---|---|---|
| | | | of non- | | | | | |
| | | | edible part | | Non-edible | | | |
| | | | to edible | Edible part | part of | | | |
| | Foodstuff containing | | part of | of edible | edible plant/ | | | |
| | dietary fiber | | dried edible | plant/whole | whole dried | Dietary | Repose | Loose bulk |
| | Foodstuff | | plant | dried powder | powder | fiber | angle | density |
| | name, origin | Details | (% by mass) | (mass ratio) | (mass ratio) | (g/100 g) | (rad) | (g/cm³) |
| Comparative | Pea powder | [Edible part] | 0 | 100.0% | 0% | 16.5 | 0.64 | 0.60 |
| Example 1 | Produced in | dried green pea | | | | | | |
| | Kagoshima | | | | | | | |
| Test Ex- | Pea powder | [Edible part] | 10 | 90.9% | 9.1% | 22.1 | 0.73 | 0.27 |
| ample 1 | Produced in | dried green pea + | | | | | | |
| | Kagoshima | [Non-edible part] | | | | | | |
| | | dried green pea (pod) | | | | | | |
| Test Ex- | Pea powder | [Edible part] | 30 | 76.9% | 23.1% | 29.6 | 0.81 | 0.19 |
| ample 2 | Produced in | dried green pea + | | | | | | |
| | Egypt | [Non-edible part] | | | | | | |
| | | dried green pea (pod) | | | | | | |
| Comparative | Carrot powder | [Edible part] | 0 | 100.0% | 0% | 14.4 | 0.59 | 0.73 |
| Example 2 | Produced in | dried carrot | | | | | | |
| | Aichi | | | | | | | |
| Test Ex- | Carrot powder | [Edible part] | 1 | 99.0% | 1.0% | 23.8 | 0.70 | 0.68 |
| ample 3 | Produced in | dried carrot + | | | | | | |
| | Aichi | [Non-edible part] | | | | | | |
| | | dried carrot (stem end) | | | | | | |
| Test Ex- | Carrot powder | [Edible part] | 3 | 97.1% | 2.9% | 28.8 | 0.75 | 0.60 |
| ample 4 | Produced in | dried carrot + | | | | | | |
| | Egypt | [Non-edible part] | | | | | | |
| | | dried carrot (stem end) | | | | | | |
| Comparative | Pumpkin powder | [Edible part] | 0 | 100.0% | 0% | 10.8 | 0.64 | 0.68 |
| Example 3 | Produced in | dried pumpkin | | | | | | |
| | the U.S. | | | | | | | |
| Test Ex- | Pumpkin powder | [Edible part] | 20 | 83.3% | 16.7% | 26.8 | 1.00 | 0.50 |
| ample 5 | Produced in | dried pumpkin + | | | | | | |
| | the U.S. | [Non-edible part] | | | | | | |
| | | dried pumpkin (seed, | | | | | | |
| | | pith) | | | | | | |
| Test Ex- | Pumpkin powder | [Edible part] | 30 | 76.9% | 23.1% | 24.7 | 0.91 | 0.37 |
| ample 6 | Produced in | dried pumpkin + | | | | | | |
| | Egypt | [Non-edible part] | | | | | | |
| | | dried pumpkin (seed, | | | | | | |
| | | pith) | | | | | | |
| Comparative | Beet powder | [Edible part] | 0 | 100.0% | 0% | 10.8 | 0.53 | 0.81 |
| Example 4 | Produced in | dried beetroot | | | | | | |
| | Hokkaido | | | | | | | |
| Test Ex- | Beet powder | [Edible part] | 50 | 66.7% | 33.3% | 20.8 | 1.03 | 0.41 |
| ample 7 | Produced in | dried beetroot + | | | | | | |
| | Hokkaido | [Non-edible part] | | | | | | |
| | | dried beetroot (skin) | | | | | | |
| Test Ex- | Beet powder | [Edible part] | 40 | 71.4% | 28.6% | 18.9 | 0.98 | 0.50 |
| ample 8 | Produced in | dried beetroot + | | | | | | |
| | Egypt | [Non-edible part] | | | | | | |
| | | beetroot (skin) | | | | | | |

| | | | | | | | Time until | | |
|---|---|---|---|---|---|---|---|---|---|
| | | | | | | | the moisture | | |
| | | | | | | | content | | |
| | | | | | | | reaches 10% | | |
| | | | | | | | by mass after | | |
| | | | | | | | addition of | | |
| | | | | | d50 after | d90 after | water, in an | Sensory | |
| | Tapped bulk | Tight bulk | Loose bulk | Tapped bulk | ultrason- | ultrason- | atmosphere | evaluation | |
| | density | density | density/tight | density/tight | ication | ication | of 70° C. | Re-drying | Resistance |
| | (g/cm³) | (g/cm³) | bulk density | bulk density | (μm) | (μm) | (min) | properties | to dampness |
| Comparative | 0.63 | 0.70 | 0.86 | 0.89 | 108.2 | 314.6 | 200 | 3 | 2 |
| Example 1 | | | | | | | | | |
| Test Ex- | 0.32 | 0.50 | 0.53 | 0.63 | 195.4 | 685.7 | 65 | 5 | 4 |
| ample 1 | | | | | | | | | |
| Test Ex- | 0.28 | 0.55 | 0.35 | 0.50 | 120.4 | 305.5 | 60 | 5 | 5 |
| ample 2 | | | | | | | | | |
| Comparative | 0.76 | 0.85 | 0.86 | 0.89 | 35.8 | 72.4 | 300 | 2 | 1 |
| Example 2 | | | | | | | | | |
| Test Ex- | 0.71 | 0.81 | 0.83 | 0.87 | 407.5 | 935.9 | 100 | 4 | 4 |
| ample 3 | | | | | | | | | |
| Test Ex- | 0.63 | 0.81 | 0.74 | 0.78 | 136.9 | 328.6 | 95 | 5 | 4 |
| ample 4 | | | | | | | | | |
| Comparative | 0.71 | 0.79 | 0.86 | 0.89 | 21.4 | 41.8 | 150 | 3 | 2 |
| Example 3 | | | | | | | | | |
| Test Ex- | 0.57 | 0.80 | 0.62 | 0.71 | 141.5 | 286.6 | 60 | 5 | 5 |
| ample 5 | | | | | | | | | |
| Test Ex- | 0.45 | 0.72 | 0.51 | 0.63 | 125.9 | 289.1 | 80 | 5 | 5 |
| ample 6 | | | | | | | | | |
| Comparative | 0.83 | 0.93 | 0.86 | 0.89 | 65.3 | 258.1 | 130 | 1 | 2 |
| Example 4 | | | | | | | | | |
| Test Ex- | 0.52 | 0.85 | 0.48 | 0.60 | 66.1 | 262.3 | 75 | 5 | 5 |
| ample 7 | | | | | | | | | |
| Test Ex- | 0.60 | 0.85 | 0.59 | 0.71 | 63.8 | 201.9 | 80 | 5 | 5 |
| ample 8 | | | | | | | | | |

TABLE 4

| | | | Proportion | | | | | |
|---|---|---|---|---|---|---|---|---|
| | | | of non- | | | | | |
| | | | edible part | | Non-edible | | | |
| | | | to edible | Edible part | part of | | | |
| | Foodstuff containing | | part of | of edible | edible plant/ | | | |
| | dietary fiber | | dried edible | plant/whole | whole dried | Dietary | Repose | Loose bulk |
| | Foodstuff name, | | plant | dried powder | powder | fiber | angle | density |
| | origin | Details | (% by mass) | (mass ratio) | (mass ratio) | (g/100 g) | (rad) | (g/cm³) |
| Comparative | Corn powder | [Edible part] | 0 | 100.0% | 0% | 8.8 | 0.64 | 0.65 |
| Example 5 | Produced | dried corn | | | | | | |
| | in the U.S. | | | | | | | |
| Test Ex- | Corn powder | [Edible part] | 150 | 40.0% | 60.0% | 26.2 | 0.91 | 0.32 |
| ample 9 | Produced | dried corn + | | | | | | |
| | in the U.S. | [Non-edible part] | | | | | | |
| | | dried corn(core) | | | | | | |
| Test Ex- | Corn powder | [Edible part] | 200 | 33.3% | 66.7% | 32.4 | 1.02 | 0.18 |
| ample 10 | Produced in | dried corn + | | | | | | |
| | Hokkaido | [Non-edible part] | | | | | | |
| | | dried corn(core) | | | | | | |
| Comparative | Green soybean | [Edible part] | 0 | 100.0% | 0% | 15.7 | 0.64 | 0.53 |
| Example 6 | powder Produced | dried green | | | | | | |
| | in the U.S. | soybean | | | | | | |
| Test Ex- | Green soybean | [Edible part] | 70 | 58.8% | 41.2% | 38.1 | 0.73 | 0.35 |
| ample 11 | powder Produced | dried green soybean + | | | | | | |
| | in the U.S. | [Non-edible part] | | | | | | |
| | | dried green soybean (Pod) | | | | | | |
| Test Ex- | Green soybean | [Edible part] | 100 | 50.0% | 50.0% | 31.0 | 0.80 | 0.25 |
| ample 12 | powder Produced | dried green soybean + | | | | | | |
| | in Hokkaido | [Non-edible part] | | | | | | |
| | | dried green soybean (Pod) | | | | | | |
| Comparative | Paprika powder | [Edible part] | 0 | 100.0% | 0% | 10.0 | 0.59 | 0.65 |
| Example 7 | Produced in | dried paprika | | | | | | |
| | New Zealand | | | | | | | |
| Test Ex- | Paprika powder | [Edible part] | 10 | 90.9% | 9.1% | 23.8 | 0.86 | 0.58 |
| ample 13 | Produced in | dried paprika + | | | | | | |
| | New Zealand | [[Non-edible part] | | | | | | |
| | | dried paprika (seed, | | | | | | |
| | | stem end) | | | | | | |
| Test Ex- | Paprika powder | [Edible part] | 20 | 83.3% | 16.7% | 20.3 | 0.91 | 0.49 |
| ample 14 | Produced in | dried paprika + | | | | | | |
| | Korea | [[Non-edible part] | | | | | | |
| | | dried paprika (seed, | | | | | | |
| | | stem end) | | | | | | |
| Comparative | Sweet potato | [Edible part] | 0 | 100.0% | 0% | 6.8 | 0.63 | 0.70 |
| Example 8 | powder Produced | dried sweet potato | | | | | | |
| | in Kagoshima | | | | | | | |
| Test Ex- | Sweet potato | [Edible part] | 75 | 57.1% | 42.9% | 12.3 | 0.72 | 0.45 |
| ample 15 | powder Produced | dried sweet potato + | | | | | | |
| | in Kagoshima | [Non-edible part] | | | | | | |
| | | dried sweet potato | | | | | | |
| | | (surface skin and | | | | | | |
| | | both ends) | | | | | | |
| Test Ex- | Sweet potato | [Edible part] | 150 | 40.0% | 60.0% | 16.6 | 0.78 | 0.35 |
| ample 16 | powder Produced | dried sweet potato + | | | | | | |
| | in Ibaraki | [Non-edible part] | | | | | | |
| | | dried sweet potato | | | | | | |
| | | (surface skin and | | | | | | |
| | | both ends) | | | | | | |
| Comparative | Soybean dietary | [Edible part] | 0 | 100.0% | 0% | 25.0 | 0.64 | 0.60 |
| Example 9 | fiber was added to | dried beetroot | | | | | | |
| | Comparative | | | | | | | |
| | Example 4 | | | | | | | |
| Comparative | Particle shape of | [Edible part] | 40 | 71.4% | 28.6% | 18.9 | 0.40 | 0.80 |
| Example 10 | Test Example 8 | dried beetroot + | | | | | | |
| | was changed | [Non-edible part] | | | | | | |
| | | beetroot (skin) | | | | | | |

| | | | | | | | Time until | | |
|---|---|---|---|---|---|---|---|---|---|
| | | | | | | | the moisture | | |
| | | | | | | | content | | |
| | | | | | | | reaches 10% | | |
| | | | | | | | by mass after | | |
| | | | | | | | addition of | | |
| | | | | | d50 after | d90 after | water, in an | Sensory | |
| | Tapped bulk | Tight bulk | Loose bulk | Tapped bulk | ultrason- | ultrason- | atmosphere | evaluation | |
| | density | density | density/tight | density/tight | ication | ication | of 70° C. | Re-drying | Resistance |
| | (g/cm³) | (g/cm³) | bulk density | bulk density | (μm) | (μm) | (min) | properties | to dampness |
| Comparative | 0.68 | 0.76 | 0.86 | 0.89 | 10.2 | 49.8 | 500 | 3 | 1 |
| Example 5 | | | | | | | | | |
| Test Ex- | 0.49 | 0.71 | 0.45 | 0.69 | 123.7 | 268.1 | 100 | 5 | 5 |
| ample 9 | | | | | | | | | |
| Test Ex- | 0.37 | 0.59 | 0.30 | 0.63 | 123.0 | 263.1 | 80 | 5 | 5 |
| ample 10 | | | | | | | | | |
| Comparative | 0.55 | 0.61 | 0.87 | 0.91 | 54.7 | 314.6 | 300 | 1 | 1 |
| Example 6 | | | | | | | | | |
| Test Ex- | 0.48 | 0.59 | 0.59 | 0.81 | 346.6 | 885.7 | 90 | 4 | 4 |
| ample 11 | | | | | | | | | |
| Test Ex- | 0.40 | 0.57 | 0.44 | 0.71 | 147.4 | 305.5 | 80 | 5 | 5 |
| ample 12 | | | | | | | | | |
| Comparative | 0.68 | 0.75 | 0.87 | 0.91 | 92.1 | 338.2 | 120 | 1 | 2 |
| Example 7 | | | | | | | | | |
| Test Ex- | 0.63 | 0.81 | 0.72 | 0.78 | 242.7 | 545.0 | 80 | 4 | 5 |
| ample 13 | | | | | | | | | |
| Test Ex- | 0.55 | 0.85 | 0.58 | 0.65 | 186.9 | 424.4 | 75 | 5 | 5 |
| ample 14 | | | | | | | | | |
| Comparative | 0.72 | 0.81 | 0.86 | 0.89 | 386.8 | 938.2 | 650 | 2 | 1 |
| Example 8 | | | | | | | | | |
| Test Ex- | 0.58 | 0.74 | 0.60 | 0.78 | 446.7 | 1025.8 | 210 | 4 | 5 |
| ample 15 | | | | | | | | | |
| Test Ex- | 0.53 | 0.71 | 0.49 | 0.74 | 508.6 | 1127.1 | 160 | 5 | 5 |
| ample 16 | | | | | | | | | |
| Comparative | 0.63 | 0.71 | 0.85 | 0.89 | 13.7 | 54.5 | 500 | 3 | 1 |
| Example 9 | | | | | | | | | |
| Comparative | 0.83 | 0.85 | 0.94 | 0.98 | 57.9 | 191.0 | 180 | 1 | 1 |
| Example 10 | | | | | | | | | |

As a result, it was found that, even when any of the edible plants were used, the time until the moisture content reaches 10% by mass after addition of water in an atmosphere of 70° C. is shorter, re-drying properties are more favorable, and the foodstuff containing dietary fiber is less likely to be damped, in the case of mixing the non-edible part with the edible part as compared with the case of only the edible part.

Then, the influence of dried edible plant powder of one or more embodiments of the present invention on the resistance to dampness of the whole dried powder was examined by using the soybean powder (containing the edible part and the non-edible part) prepared in Test Example 12. Sugar powder having d90 of 500 μm was used as an example of the dried powder other than the dried edible plant powder, and as shown in Table 5, the content of the dried edible plant based on the whole dried powder is changed, and the sensory evaluation was carried out for the resistance to dampness of the whole dried powder in the same manner as in the above test.

The results are shown in Table 5.

TABLE 5

| | | | | Time until | | |
|---|---|---|---|---|---|---|
| | | | | the moisture | | |
| | | | | content | | |
| | | | | reaches 10% | | |
| | | | Content of | by mass after | | |
| | Dried powder | | dried edible | addition of | | |
| | | Other | plant based | water, in an | | |
| | Dried edible plant | foodstuff | on the whole | atmosphere | Sensory evaluation | |
| | (prepared in Test | (dried | powder | of 70° C. | Re-drying | Resistance |
| | Example 12) | powder) | (% by mass) | (min) | properties | to dampness |
| Comparative | [Edible part] | Sugar (d90 = | 0 | 400 | 1 | 1 |
| Example 11 | dried green soybean + | 500 μm) | | | | |
| Test Ex- | [Non-edible part] | | 10 | 260 | 4 | 4 |
| ample 17 | dried green soybean (Pod) | | | | | |
| Test Ex- | | | 20 | 210 | 5 | 4 |
| ample 18 | | | | | | |
| Test Ex- | | | 30 | 170 | 5 | 4 |
| ample 19 | | | | | | |
| Test Ex- | | | 40 | 150 | 5 | 4 |
| ample 20 | | | | | | |
| Test Ex- | | | 50 | 120 | 5 | 5 |
| ample 21 | | | | | | |
| Test Ex- | | | 60 | 100 | 5 | 5 |
| ample 22 | | | | | | |
| Test Ex- | | | 70 | 90 | 5 | 5 |
| ample 23 | | | | | | |
| Test Ex- | | | 80 | 85 | 5 | 5 |
| ample 24 | | | | | | |
| Test Ex- | | | 90 | 83 | 5 | 5 |
| ample 25 | | | | | | |
| Test Ex- | | | 100 | 80 | 5 | 5 |
| ample 26 | | | | | | |

As a result, it was found that, when the dried edible plant containing an edible part and a non-edible part is mixed based on the whole dried powder, the whole dried powder is less likely to be damped. Therefore, it was found that the content of the dried edible plant based on the whole dried powder dominantly exerts its characteristics (an effect of making the dried powder less damped) over the whole dried powder.

The dried edible plant containing an edible part and a non-edible part of one or more embodiments of the present invention is expected to be applied mainly in the food product field thanks to the effect of imparting resistance to dampness accompanying an improvement of re-drying properties with respect to the dried powder.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

1. A dried powder comprising an edible part and a non-edible part of a dried edible plant, satisfying the following conditions (1) to (4):
(1) a proportion of the non-edible part to the edible part of the dried edible plant is 1% by mass or more and 200% by mass or less;
(2) a repose angle is 0.7 rad or more;
(3) a ratio of a loose bulk density to a tight bulk density is 0.88 or less; and
(4) a moisture content is 20% by mass or less.

2. The dried powder according to claim 1, further satisfying (5):
(5) a content of dietary fiber is 18% by mass or more.

3. The dried powder according to claim 1, further satisfying (6):
(6) a d90 after ultrasonication is 2,000 μm or less.

4. The dried powder according to claim 1, further satisfying (7):
(7) a ratio of a tapped bulk density to the tight bulk density is 0.85 or less.

5. The dried powder according to claim 1, comprising the non-edible part of the dried edible plant in an amount of 1% by mass or more and 90% by mass or less based on a total mass of the dried powder.

6. The dried powder according to claim 1, wherein the edible part and the non-edible part of the dried edible plant are derived from one kind of edible plant.

7. The dried powder according to claim 1, wherein the edible part and the non-edible part of the dried edible plant are derived from one edible plant.

8. The dried powder according to claim 1, wherein the dried edible plant is one or more selected from the group consisting of cereals, potatoes, pulses, nuts/seeds, vegetables, fruits, and mushrooms.

9. The dried powder according to claim 1, wherein the dried edible plant is one or more selected from the group consisting of paprika, beets, soybeans, corns, carrots, pumpkins, peas, broad beans, sweet potatoes, broccoli, spinaches, and kales.

10. The dried powder according to claim 1, wherein the dried powder is packaged in a sealed container with no drying agent.

11. The dried powder according to claim 1, wherein a content of the dried edible plant is 10% by mass or more based on a total mass of the dried powder.

12. The dried powder according to claim 1, wherein a content of silicon is 1,000 ppm or less.

13. The dried powder according to claim 1, wherein the dried powder is for human ingestion.

14. A food comprising the dried powder according to claim 1.

15. A beverage comprising the dried powder according to claim 1.

16. A method for producing the dried powder according to claim 1 comprising grinding the dried edible plant having the moisture content of 20% by mass or less.

17. A method for producing a dried powder comprising grinding a dried edible plant having a proportion of a non-edible part to an edible part of 1% by mass or more and 200% by mass or less, and a moisture content of 20% by mass or less until a repose angle reaches 0.7 rad or more and a ratio of a loose bulk density and a tight bulk density reaches 0.88 or less.
